(19) United States
(12) Patent Application Publication
(10) Pub. No.: US 2005/0132042 A1
(43) Pub. Date: Jun. 16, 2005

(54) HTTP protocol-based internet document rating system

(76) Inventor: Martin Cryer, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/886,188

(22) Filed: Jul. 7, 2004

Related U.S. Application Data
(60) Provisional application No. 60/485,375, filed on Jul. 7, 2003.

(51) Int. Cl. G06F 15/173

(52) U.S. Cl. 709/224; 709/225

(57) ABSTRACT

Methods and apparatus for using http protocol for filtering and monitoring Internet access are disclosed. An agent device, such as a router, hub, or client, use http commands to request a web page document from a web page document server and to request ratings for the web page document. The agent device can evaluate a response for a request for a web page document rating to determine if a user is authorized to view the requested web page document. If the user is authorized to view the web page document, the web page document is delivered to the user. If the user is not authorized to view the web page document, the user is blocked from viewing the web page document, and/or a category for the web page document is recorded as having been attempted access by the user.

### CROSS REFERENCE TO RELATED APPLICATIONS

This application claims the benefit of U.S. Provisional Application No. 60/485,375 titles “HTTP PROTOCOL-BASED INTERNET DOCUMENT RATING SYSTEM” filed Jul. 7, 2003 which is incorporated herein by reference.

### BACKGROUND OF THE INVENTION

1. The Field of the Invention

The invention generally relates to rating web page documents. More specifically, the invention relates to providing web page document ratings in response to a request for a web page document.

2. Description of the Related Art

The Internet is a vast repository of information. The Internet allows individuals, companies, and other organizations to author and publish information that becomes readily available to Internet users. The Internet allows the interconnection of various web page document servers. There exist numerous software programs that allow quick and cheap authoring and publication of Web page documents to web page document servers. These factors have resulted in the continued proliferation of web page documents at an astounding rate. In addition to information, the websites may also offer services and entertainment functions.

There exists currently very little editorial control of what is published on the Internet. In general, there are virtually no standards for accuracy and in many cases little or no standards for decency. Further, the ubiquity of the Internet has allowed material to be retrieved to a location where the material may be illegal or questionable from a location where the material is less regulated. For example, a gambling web site may be operated from a location that allows legalized gambling where a user in a location where gambling is not legal may access the web site and be allowed to gamble using the web site.

The ready availability of questionable material has created various problems in corporate and home environments. In the corporate environment, an employee's ability to access pornography or other objectionable material may create a hostile work environment for other employees subjecting the corporation to various legal liabilities. Additionally, employee productivity may suffer as a result of employees accessing the Internet for personal reasons while the employees should be performing company tasks.

In a home environment, parents may have an in an interest in controlling the content in web page documents accessible by children or others in the home. Web page operators currently provide little protection to prevent children from accessing sites that may include pornography, gambling, hate and racism, and other dangerous activities.

Presently, some filtering of Web page documents is done by software installed on client computers. However, this requires constant updating of a database on the client to maintain a list of approved and not approved sites. Additionally, this filtering software may be disabled by tech savvy employees or children. Further, software installed on a client provides no provision for new sites or new Web page documents. With respect to the shortcoming of currently used client installed filters, many publishers of questionable material use changes in IP addresses and domain names specifically to avoid such filtering software. Appropriate correction is needed.

### BRIEF SUMMARY OF THE INVENTION

Embodiments are generally directed to using http to request and receive ratings for web page documents. One embodiment includes a method of controlling and/or monitoring activities such as accessing web page documents through the Internet. The method includes receiving a request for a web page document. An http request is then made to a web page document server for the web page document. Prior to, simultaneously with, or subsequent to the request for the web page document, an http request is made for a rating for the web page document. A rating is then received for the web page document.

In another embodiment of the invention, an agent device is used for filtering and/or monitoring Internet access. The agent device includes a module configured to receive an http request for a web page document. This request may, in one example, be received from a client connected to the agent, where the agent is a specially designed router or hub. The agent device may also include a ratings request module that is configured to generate an http request for a rating for the web page document. The agent device includes a WAN port connected to the ratings request module. Thus, the request for a rating for the web page document may be forwarded to the Internet. The agent device may also receive responses to the request for the rating for the web page document through the WAN port.

Another embodiment of the invention includes a service configured to provide Internet monitoring and/or filtering functionality. The service includes one or more ratings servers. The ratings servers include a cache that stores ratings for web page documents. The service also includes a proxy cache connected to the ratings server. The proxy cache is configured to respond to http requests and to deliver web page document ratings. The ratings may be stored as cached documents associated with a web page document url.

Another embodiment of the invention includes a method of providing ratings for web page documents. The method includes an act of receiving an http request for the web page document rating from an agent device such as a router, hub, client and the like. A check is then done to see if the web page document rating is in a local cache. If the web page document rating is in a local cache, the web page document rating is sent to the agent device requesting the rating. If the web page document rating is not in local cache, the method includes an act of checking to see if the web page document rating is in a proxy cache. Check to see if the web page document rating is in a proxy cache may be performed by sending an http request for the web page document to the proxy cache where the rating is stored as the content of the web page document in the proxy cache. If the web page document rating is in the proxy cache, the web page document rating is then sent to the agent device requesting the rating. If the web page document is not in the proxy cache, a request is sent to a dynamic rater for rating. The url for the web page document is also sent to a background rater for generating a more accurate rating. If the dynamic rater is able to quickly generate a rating for the web page document, the web page document rating is sent to the agent device requesting the rating.

Advantageously, using http requests allows the service to be constructed cost efficiently and to be integrated easily with existing Internet protocols and technology. Further, by the ratings being maintained by a ratings service accessible via the Internet, the ratings can be maintained such that they are current. Further, a large rating database can be maintained by the ratings service without large storage burdens on clients requesting the web page ratings.

These and other advantages and features of the present invention will more fully apparent from the following description and appended claims, or learned by the practice of the invention as set forth hereinafter.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a topology including an agent device connected to a web page document server and a ratings server through an internet connection;

FIG. 2 illustrates a method of requesting and receiving web page document ratings;

FIG. 3 illustrates a ratings service useful for generating and delivering web page document ratings to agent devices requesting the ratings; and

FIG. 4 illustrates a method of delivering and generating web page document ratings from a ratings service.

### DETAILED DESCRIPTION OF THE INVENTION

The present invention extends to both methods and systems for an http protocol based Internet document rating system. The embodiments of the present invention may comprise one or more special purpose and/or one or more general purpose computers including various computer hardware, as discussed in greater detail below.

The present invention also may be described in terms of methods comprising functional steps and/or non-functional acts. The following is a description of acts and steps that may be performed in practicing the present invention. Usually, functional steps describe the invention in terms of results that are accomplished, whereas non-functional acts describe more specific actions for achieving a particular result. Although the functional steps and non-functional acts may be described or claimed in a particular order, the present invention is not necessarily limited to any particular ordering or combination of acts and/or steps.

Although not required, the invention will be described in the general context of computer-executable instructions, such as program modules, being executed by computers or microprocessors in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-reading media. Computer-executable instructions comprise, for example, instructions and data which cause a general purpose computer, special purpose computer, or special purpose processing device to perform a certain function or group of functions.

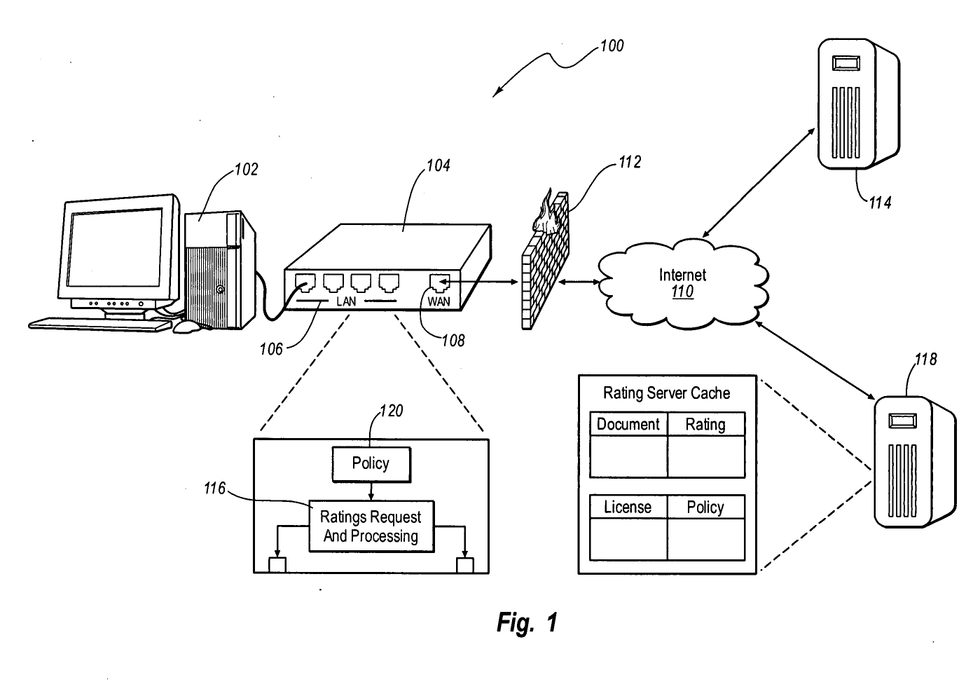

Referring now to FIG. 1, a topology 100 where aspects of the present invention may be practiced is shown. The topology 100 includes a network client 102. The network client 102 includes software such as an Internet browser for sending and receiving http messages. While the network client 102 is shown here as a personal computer, devices performing the function of the network client 102 in other embodiments of the invention may include various other types of devices including but not limited to PDAs, network appliances and the like. The network client 102 further includes networking hardware such as a network interface card (NIC). As shown in the topology 100, the NIC of the network client 102 is connected to an agent device that in this example is a router 104. The router 104 includes local area network (LAN) ports 106 and a wide area network (WAN) port 108. The LAN ports 106 are generally used to interconnect a number of clients 102 to form a local network for sending and receiving data between the local clients 102. The WAN port allows the local network comprised of the local clients 102 to be connected to a wide area network such as the Internet, for sending and receiving data on a larger scale.

The network client 102 connects to the router 104 through one of the LAN ports 106. The router 104 is connected to the Internet 110 through a firewall 112. The firewall 112 is configured to prevent certain types of data from leaving the router 104 or being received by the router from the Internet 1 10. The router 104 is connected to the Internet 110 through the WAN port 108. The WAN port 108 may connect to the Internet through connections such as dial-up connections used by a standard modem, cable Internet connections using cable modems, wireless Internet connections and the like. The Internet 110 allows the router 104, and thus the network client 102, to access web page documents existing on a web document server 114.

One embodiment of the invention allows a categorization for a web page document to be retrieved in conjunction with the retrieval of the web page document. The categorization for the web page document allows the web page document to be sorted into different categories depending on the content of the web page document. Illustrative categorizations include: arts, education, news, auction, pornography, drugs, and the like. Categories used in one embodiment of the invention are discussed in more detail below. A web page document may belong to more than one category.

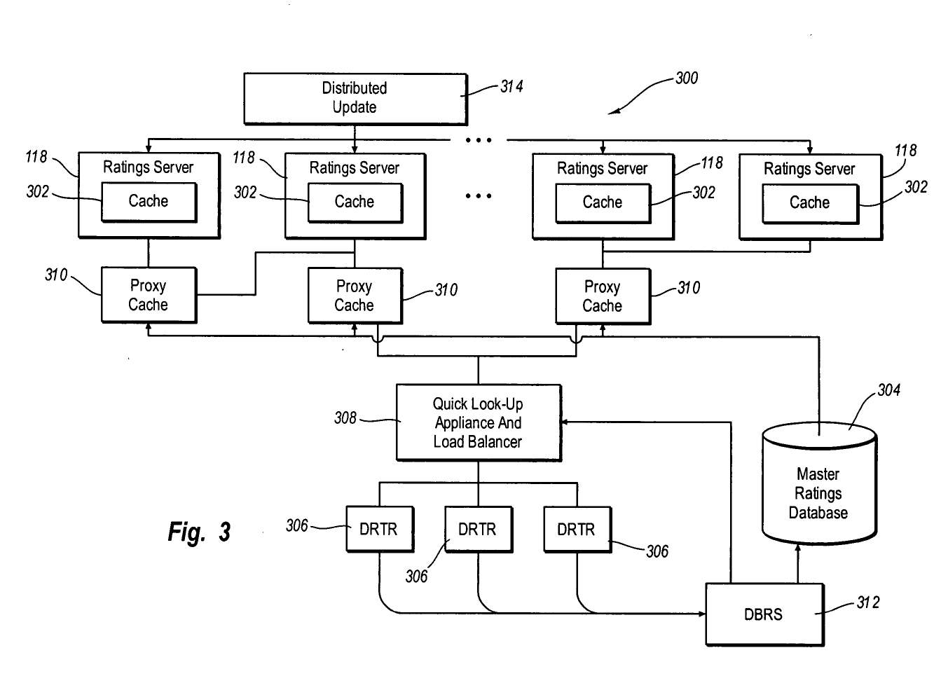

Illustrating the functionality of the embodiment shown in FIG. 1, a user at the network client 102 issues an http request for a web page document by entering a web page address into a web browser on the network client 102. The network client sends the request to the router 104. The router includes a module to receive the http request for the web page document. The router 104 also includes a ratings request and processing module 116. Notably, the module for receiving the http request may be the same module as the ratings request and processing module. Likewise, the functionality of the ratings request and processing module may be distributed among one or more different modules. The ratings request and processing module 116 causes two connections to be opened. One connection is opened with the web page document server 114 and one connection is opened with the ratings server 118. A first http GET command is issued to the web page document server 114 and causes the web page document requested by the user at the client to be retrieved from the web page document server 114. A second GET command requests a categorization of the web page document requested from the web document server 114 from a ratings server 118. The ratings server 118 contains ratings for various web page documents. The ratings server 118 may be part of a larger ratings service with a number of other ratings servers, dynamic rating equipment, policy storage equipment, and the like. Details of exemplary ratings services will be discussed in more detail below in conjunction with the description of FIG. 3. Both the web document server 114 and the ratings server 118 are accessible via the Internet 110.

When the router 104 has received both the web page document and categorization of the web page document, the router, using a policy module 120, can determine if a user at the network client 102 is allowed to view the web page document retrieved from the web page document server 114. If the web page document falls in a category of web page documents that are allowed to be viewed by a user at the network client 102, the router 104 will forward the web page document to the network client 102 for viewing by the user. If the web page document does not fall within a category of web page documents that are allowed to be viewed by a user at the network client, the router will send a blocked message web page document indicating that the particular web page document requested by the user at the network client 102 has been blocked. The blocked message web page document may be stored or generated by the router 104. Alternatively, the router may redirect the request from the network client 102 to a blocked web page document on a web page server. In another embodiment of the invention, the blocked web page document may be tunneled (embedded in a response) to the router 104 from a web server where it is passed on to the network client 102.

In the embodiment shown in FIG. 1, policy information is contained in the policy module 120 to determine when web pages documents are to be blocked from a particular network client 102. The policy information is a set of specifications detailing what document categories to allow, what document categories to block etc. The policy information may be user specific such that certain users are allowed to view web page documents in categories that are not allowed to be viewed by other users. The policy information may also block web page documents in certain categories from being displayed at certain times of the day. For example, in a corporate setting, the policy information may allow auction and day trading sites to be viewed during a lunch hour, but not at other times of the day.

In addition to or in lieu of blocking web page documents, the policy module 120 may contain software for monitoring and logging Internet use by users at a network client 102. Logging may be used to provide a network administrator, corporate steering, or parents with information about what categories of web page documents are being viewed by a particular user. Logging functions may also be provided in one embodiment, by a ratings service that maintains the ratings servers. Logging functionality will be discussed in more detail below.

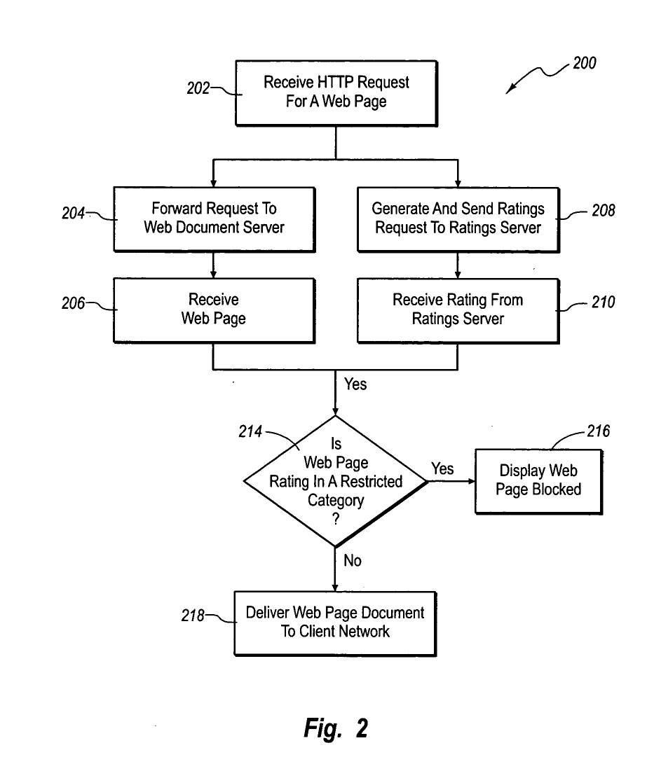

Referring now to FIG. 2, a flow chart illustrating a method for web page filtering is shown. The method 200 begins with an act of receiving an http request for a web page (202). This act (202) may be performed for example by an agent device such as the router 104 shown in FIG. 1. The router 104 receives a request from a network client 102. The method 200 then branches and proceeds with two separate courses of action. In one act, the request is forwarded to a web documents server (204). This Act (204) may be performed by a router 104 which sends a request for a web page document through the internet 110 to a web page document server 114. As a result of sending a request for the web page document (204), the requested web page document is sent by the web document server 114 and received by the router 104 (206). Meanwhile, a ratings request is generated and sent to a ratings server (208) such as the ratings server 118 shown in FIG. 1. Generating and sending a request for a rating (208) may be performed for example by the ratings request and processing module 116 in the router 104 shown in FIG. 1. As a result of generating and sending a ratings request (208), ratings are sent from the ratings server 118 to the router 104 where they are received by the router (210). FIG. 2 illustrates the retrieval of a web page document and a rating for the web page document occurring simultaneously. However, other embodiments contemplate retrieval of the web page document and web page document ratings occurring subsequent to one another. The method 200 checks to see if the web page document rating is in a restricted category (214). If the web page document is in a restricted category, a web page will be displayed to the user at a network client 102 that indicates that the web page is blocked (216). If the web page document rating is not in a restricted category the router 104 will deliver the web page document, once received to the network client 104 (218). Also, because a decision to block a web page (214) can be made after a rating has been received from the ratings server (210) and prior to completion of receiving the web page (206), the transaction may be completed early prior to receiving the complete web page or any part of it. This may help to conserve network bandwidth by not downloading web pages or portions of web pages once a ratings has been received that indicates that the web page should be blocked.

Categories

It is often desirable, as mentioned above to limit access to content on the internet based on the content falling within specific categories. The following categories represent a sampling of categories that may be used to categorize web page documents. The following list is not exhaustive or a list of necessary categories and embodiments of the invention allow for other categories to be used. Categories may be identified, in one example, by a numerical identifier associated with the category.

Overrides

The URL has been matched against a system-wide or per-user policy override list and is always allowed or always blocked, depending upon the policy in place for a given user.

Adult/Mature Content

Sites that contain material of adult nature that does not necessarily contain excessive violence, sexual content, or nudity. These sites include very profane or vulgar content and sites that are not appropriate for children. Pornography: sites that contain sexually explicit material for the purpose of arousing a sexual or prurient interest.

Sex Education

Sites that provide information (sometimes graphic) on reproduction, sexual development, safe sex practices, sexuality, birth control, and sexual development. Also includes sites that offer tips for better sex as well as products used for sexual enhancement.

Intimate Apparel/Swimsuit

Sites that contain images or offer the sale of swimsuits or intimate apparel or other types of suggestive clothing. Does not include sites selling undergarments as a subsection of other products offered.

Nudity

Sites containing nude or seminude depictions of the human body. These depictions are not necessarily sexual in intent or effect, but may include sites containing nude paintings or photo galleries of artistic nature. This category also. includes nudist or naturist sites that contain pictures of nude individuals.

Alcohol/Tobacco

Sites that promote or offer for the sale alcohol/tobacco products, or provide the means to create them. Also includes sites that glorify, tout, or otherwise encourage the consumption of alcohol/tobacco. Does not include sites that sell alcohol or tobacco as a subset of other products.

Illegal/Questionable

Sites that advocate or give advice on performing illegal acts such as service theft, evading law enforcement, fraud, burglary techniques and plagiarism. Also includes sites that provide or sell questionable educational materials, such as term papers.

Gambling

Sites where a user can place a bet or participate in a betting pool (including lotteries) online. Also includes sites that provide information, assistance, recommendations, or training on placing bets or participating in games of chance. Does not include sites that sell gambling related products or machines. Also does not include sites for offline casinos and hotels (as long as those sites do not meet one of the above requirements).

Violence/Hate/Racism

Sites that depict extreme physical harm to people or property, or that advocate or provide instructions on how to cause such harm. Also includes sites that advocate, depict hostility or aggression toward, or denigrate an individual or group on the basis of race, religion, gender, nationality, ethnic origin, or other involuntary characteristics.

Weapons

Sites that sell, review, or describe weapons such as guns, knives or martial arts devices, or provide information on their use, accessories, or other modifications. Does not include sites that promote collecting weapons, or groups that either support or oppose weapons use.

Abortion

Sites that provide information or arguments in favor of or against abortion, describe abortion procedures, offer help in obtaining or avoiding abortion, or provide information on the effects, or lack thereof, of abortion.

Entertainment

Sites that promote and provide information about motion pictures, videos, television, music and programming guides, books, comics, movie theatres, galleries, artists or reviews on entertainment.

Business/Economy

Sites devoted to business firms, business information, economics, marketing, business management and entrepreneurship. This does not include sites that perform services that are defined in another category (such as Information Technology companies, or companies that sell travel services).

Cult/Occult

Sites that promote or offer methods, means of instruction, or other resources to affect or influence real events through the use of spells, curses, magic powers, satanic or supernatural beings.

Illegal Drugs

Sites that promote, offer, sell, supply, encourage or otherwise advocate the illegal use, cultivation, manufacture, or distribution of drugs, pharmaceuticals, intoxicating plants or chemicals and their related paraphernalia.

Education

Sites that offer educational information, distance learning and trade school information or programs. Also includes sites that are sponsored by schools, educational facilities, faculty, or alumni groups.

Cultural Institutions

Sites sponsored by cultural institutions, or provide information about museums, galleries, theatres (not movie theaters). Includes groups such as 4H and the Boy Scouts of America.

Financial Services

Sites that provide or advertise banking services (online or offline) or other types of financial information, such as loans. Does not include sites that offer market information, brokerage or trading services.

Brokerage/Trading

Sites that provide or advertise trading of securities and management of investment assets (online or offline). Also includes insurance sites, as well as sites that offer financial investment strategies, quotes, and news.

Games

Sites that provide information and support game playing or downloading, video games, computer games, electronic games, tips, and advice on games or how to obtain cheat codes. Also includes sites dedicated to selling board games as well as journals and magazines dedicated to game playing. Includes sites that support or host online sweepstakes and giveaways.

Government/Legal

Sites sponsored by or which provide information on government, government agencies and government services such as taxation and emergency services. Also includes sites that discuss or explain laws of various governmental entities.

Military

Sites that promote or provide information on military branches or armed services.

Political/Activist Groups

Sites sponsored by or which provide information on political parties, special interest groups, or any organization that promotes change or reform in public policy, public opinion, social practice, or economic activities.

Health

Sites that provide advice and information on general health such as fitness and wellbeing, personal health or medical services, drugs, alternative and complimentary therapies, medical information about ailments, dentistry, optometry, general psychiatry, self-help, and support organizations dedicated to a disease or condition.

Computers/Internet

Sites that sponsor or provide information on computers, technology, the Internet and technology-related organizations and companies.

Hacking/Proxy Avoidance

Sites providing information on illegal or questionable access to or the use of communications equipment/software, or provide information on how to bypass proxy server features or gain access to URLs in any way that bypasses the proxy server.

Search Engines/Portals

Sites that support searching the Internet, indices, and directories.

web Communications

Sites that allow or offer web-based communication via e-mail, chat, instant messaging, message boards, etc.

Job Search/Careers

Sites that provide assistance in finding employment, and tools for locating prospective employers.

News/Media

Sites that primarily report information or comments on current events or contemporary issues of the day. Also includes radio stations and magazines. Does not include sites that can be rated in other categories.

Personals/Dating

Sites that promote interpersonal relationships.

Reference

Sites containing personal, professional, or educational reference, including online dictionaries, maps, census, almanacs, library catalogs genealogy-related sites and scientific information.

Chat/Instant Messaging

Sites that provide chat or instant messaging capabilities or client downloads.

Email Sites offering web-based email services, such as online email reading, e-cards, and mailing list services.

Newsgroups Sites that offer access to Usenet news groups or other messaging or bulletin board systems.

Religion

Sites that promote and provide information on conventional or unconventional religious or quasi-religious subjects, as well as churches, synagogues, or other houses of worship. Does not include sites containing alternative religions such as Wicca or witchcraft (Cult/Occult) or atheist beliefs (Political/Activist Groups).

Shopping

Sites that provide or advertise the means to obtain goods or services. Does not include sites that can be classified in other categories (such as vehicles or weapons).

Auctions

Sites that support the offering and purchasing of goods between individuals. Does not include classified advertisements.

Real Estate

Sites that provide information on renting, buying, or selling real estate or properties.

Society/Lifestyle

Sites providing information on matters of daily life. This does not include sites relating to entertainment, sports, jobs, sex or sites promoting alternative lifestyles such as homosexuality. Also, personal homepages fall within this category if they cannot be classified in another category.

Gay/Lesbian

Sites that provide information, promote, or cater to gay and lesbian lifestyles. Does not include sites that are sexually oriented.

Restaurants/Dining/Food

Sites that list, review, discuss, advertise and promote food, catering, dining services, cooking and recipes.

Sports/Recreation/Hobbies

Sites that promote or provides information about spectator sports, recreational activities, or hobbies. Includes sites that discuss or promote camping, gardening, and collecting.

Travel

Sites that promote or provide opportunity for travel planning, including finding and making travel reservations, vehicle rentals, descriptions of travel destinations, or promotions for hotels or casinos.

Vehicles

Sites that provide information on or promote vehicles, boats, or aircraft, including sites that support online purchase of vehicles or parts.

Humor/Jokes

Sites that primarily focus on comedy, jokes, fun, etc. May include sites containing jokes of adult or mature nature. Sites containing humorous Adult/Mature content also have an Adult/Mature category rating.

Streaming Media/MP3

Sites that sell, deliver, or stream music or video content in any format, including sites that provide downloads for such viewers.

Downloads

Sites that are dedicated to the electronic download of software packages, whether for payment or at no charge.

Pay to Surf

Sites that pay users in the form of cash or prizes, for clicking on or reading specific links, email, or web pages

For Kids

Sites designed specifically for children.

web Advertisement

Sites that provide online advertisements or banners. These sites will always be allowed. Does not include advertising servers that serve adult-oriented advertisements.

web Hosting

Sites of organizations that provide top-level domain pages, as well as web communities or hosting services.

Unrated

Sites that are not rated into any other category.

Miscellaneous

Sites that have been chosen not to be rated because they do not conform to a standard category definition.

Category Membership Request (CMR) Protocol

Referring once again to FIG. 1, and as described previously, once a connection has been established with the ratings server 118, a GET command is used to request rating from the ratings server 118. In one embodiment, the GET command conforms to a Category Membership Request (CMR) protocol. Using the CMR protocol, the GET command includes arguments including a customer license identifier, a list of categories and a URL for the requested web page document. The ratings server 118 will respond to a CMR command by indicating that the requested web page document is, or is not in at least one of the categories sent in the list of categories argument of the CMR GET command. This response may be, in one embodiment, an XML document. Thus, in one embodiment of the invention, the router 104 constructs a CMR GET command that includes an argument with a web page document requested by a user at the network client 102 and an argument with a list of categories that a user at the network client 102 is not allowed to view. If the ratings server 118 returns a response to the router 104 that indicates that the web page document requested by the user at the network client 102 is in at least one of the categories in the list of categories argument, the router will block the web page document.

The CMR protocol may be useful in embodiments where policy rules are maintained locally where network clients 102 are interconnected on a local network. Illustratively, policy information including rules about what users at network clients 102 can access what web page documents, may be maintained in the policy module 120. When a router receives a request for a web page document, the router also receives information about what network client 102 is making the request. This may be in the form of an IP address, username, or other identifier.

An exemplary CMR GET command is as follows: GET/C/vend/ID/License/log_Id/categories/protocol/hosts/port/url/HTTP 1.1. The arguments of the CMR GET command are as follows. C identifies the CMR protocol, VendId identifies an OEM partner. For example, the VendId argument may identify a router manufacturer that implements filtering functionality in the router. License identifies a network client's right to receive filtering services. The license may be, in one example, a username, password or string identifying a particular license. Log_id identifies a value that may be logged in conjunction with the request. For example, the log_id argument may identify a user making the request, where that user can be logged, along with information about a requested web page document, at a ratings service. Categories identifies the list of categories sent to the ratings server. As mentioned above, this list of categories may correspond to categories that should be blocked for a particular user. A category may be identified by a numerical identifier. Protocols identifies the protocol used for requesting the web page document. This protocol may be, for example, HTTP, HTTPS, FTP, NNTP and the like. Host identifies the host server that has the web page document. The host server may be identified by an IP address or by domain name. Preferably, the host is identified by domain name. This allows the ratings to be cached and used for subsequent rating requests even when a dynamic IP address is used for an internet resource such as a web page document server. Port identifies a logical connection to which messages are directed on the server. For example, HTTP messages are usually directed to port 80. URL identifies the path of the requested web page document, and HTTP 1.1 identifies the HTTP protocol of the GET command.

Access Determination Request (ADR) Protocol

Another embodiment of the present invention uses an Access Determination Request (ADR) protocol. Policy information, i.e. information as to web page documents that a user is blocked from, may be maintained by the ratings server 118 or a rating service. An agent device, such as the router 104, needs only to send an identification identifying a user with a web page document address to the ratings server 118. The ratings server 118 can then determine, based on the policy information, whether or not a web page document should be blocked. The ADR protocol is suited for uses where policy information is maintained at the ratings server 118 or a rating service.

A typical ADR GET command is as follows: GET/A/VendID/License/user_id/-/protocol/host/port/url/HTTP1.1. The arguments are similar to the GET command used in the CMR protocol. The A argument identifies that this request is an ADR GET command. In the place of a log_ID argument, a user_id argument is sent. The user_id argument can be used by the ratings server 118 or a ratings service to determine the identity of a user requesting a web page document. The ratings server 118 or rating service uses the user_id to determine if a requested web page document falls into a category that is to be blocked to the particular user. As outlined above, the ratings server 118 or ratings service maintains policy information for each user. Thus user identification is used to determine if a block message should be returned in response to a request by a user for a web page document. Because policy information is maintained at the ratings server 118 or rating service, there is no need to send a list of categories. The list of categories, in this embodiment is replaced with a—representing an empty set.

Response to Request for Ratings from the Ratings Server

The ratings server 118 will return a response to the ADR or CMR request for a rating for a web page document. The response, in one embodiment of the invention will be an XML document. XML documents are similar in form to HTML documents, except that the author of the XML document chooses their own custom defined tags. In the embodiments illustrated herein, four tags are used. These tags are <Result>, <Code>, <BlkC>, and <DomT>.

The <Result> tag encapsulates all other tags. The <Code> tag defines a logical bitmap of information flags set by a ratings service, which may be optionally processed by the requesting agent. These codes may be used to communicate that a page should be blocked, compatibility issues, server errors, license errors and syntax errors.

Additionally, a number of other code values may be returned in the <Code> tag. These codes may provide additional information about ratings returned or why ratings are not returned. For example, the code may contain information indicating that a source for a rating was a static database entry (i.e. a rating existed in a database at a ratings service) as opposed to the result of a dynamic rating (i.e. no rating existed at the ratings service, thus a rating had to be generated for the web page document dynamically prior to sending the rating to a requesting client). The code may also indicate that a license provided is not authorized for certain types of services requested.

The <BlkC> tag contains a numerical identifier for a category for which a blocked state results. A blocked state occurs for an ADR message when the URL in the URL argument is such that the user requesting a web page document should not be allowed to view the contents of the document defined by the URL. A blocked state occurs for a CMR message when the requested web page document as defined by the provided URL, is determined to be a member of the list of categories that was provided in the list of categories argument. In this latter case, membership in a category list implies membership in a list of blocked categories. The <BlkC> tag is returned only for a blocked condition otherwise the tag is omitted. The use of this returned data is used when a blocking web page document is produced by an agent device.

The <DomT> tag specifies the domain or virtual domain rating result for a CMR message. The data contained in this tag may be in one example a rating results specified as a pair of uppercase binary coded hexadecimal characters. Only one rating is returned. For instance, if the category the URL was rated as was 210A (a hexadecimal rating of both category 21 and category 0A) the field would contain the character string “21” if 21 was in the categories list of the CMR request. This tag in one embodiment is only returned for specific license types and is not a generally available feature.

Rating Service Architecture

Referring now to FIG. 3, an example of a rating service is illustrated. The ratings service 300 communicates with agent devices such as the router 104 in FIG. 1 through ratings servers 118. The ratings servers 118 maintain a local cache 302 of ratings for web page documents. In one presently preferred embodiment of the invention, ratings are maintained for web page documents by rating a domain or path as opposed to a rating for each individual web page. For example, any page under the path www.badsite.com may be rated as pornography or some other category. Often a domain may have several different types of documents such that a path may be rated differently than the domain to which it belongs. For example, www.geocities.com is a popular domain where users can post their own individual web pages. The individual web pages may cover a variety of topics from the innocuous to the graphic and offensive. Thus, in one embodiment of the invention, the path www.geocities.com/childrensbooks may be rated education whereas www.geocities.com/badsite may be rated as pornography or hate. Nonetheless, as used herein, rating web page documents or providing ratings for web page documents does not necessarily mean that a rating is performed or provided based on the specific content of the web page document, but may mean that the rating is performed or provided based on a domain or other path.

The local cache 302 may also maintain logging information for users who have chosen to have the rating service 300 maintain a log of web page categories visited by users. Additionally, the local cache may maintain policy information, i.e. information related to what users are allowed to view what categories, such as when the ADR protocol described above is used.

FIG. 3 illustrates a number of ratings servers 118. The ratings servers 118 may be geographically distributed in various locations to speed connections times to the ratings servers 118. An agent device can connect to a ratings server 118 physically near the agent device. While physical proximity may be used as one criterion for determining which ratings server 118 an agent device connects to, other criteria such as an effort to balance the loads of the ratings servers 118 may also be used. Thus for example, if one ratings server 118 is particularly busy, a request for a web page document rating may be sent to a less busy, possibly further away, ratings server 118.

The number of ratings servers 118 is scalable such that as a need arises for more ratings servers 118 or ratings servers 118 closer to a given location, additional ratings servers 118 may be added to the ratings service 300. Each of the ratings servers 118 has the local cache 302 updated periodically. Ideally, each of the ratings servers 118 should have the same cached information in their respective local cache 302. A master ratings database 304 maintains ratings for web page documents. Using a distributed update module 314, the information from the master ratings database 304 can be distributed to the different ratings servers 118 where it may be maintained in the local cache 302.

With the constantly changing nature of the Internet, ratings for web page documents may often not exist in a local cache 302 on a ratings server 118 or in the master rating database 304. This may occur when a new web page document has been made accessible via the Internet. Additionally, because web page documents can change, one embodiment of the invention contemplates rating being cacheable for a limited time. When a time limit expires, a rating for the web page document is no longer considered valid. Thus, exemplary embodiments of the invention allow for web page documents to be rated dynamically by an automated process that examines the text in the web page document.

Dynamic Real Time Ratings (DRTR) modules 306 are used to provide a quick automated rating for web page document ratings not stored in the local caches 302 on the ratings servers 118.

A request for an unrated web page document is forwarded to a quick look-up appliance and load balancer 308. The quick look-up appliance and load balancer 308 distributes the request to a DRTR module 306 to provide a dynamic rating. If the DRTR module 306 can provide a rating quickly or in a reasonable amount of time, e.g. within a few seconds, the rating is sent back to an agent device requesting the rating. If the rating cannot be generated quickly, a not ratable response is sent back to the agent device requesting the rating. In either case, the response, including a rating or not ratable, is cached in one of a number of proxy cache 310. The rating may be given a short time to live, e.g. a few minutes, until a more reliable rating of the web page document can be generated. Thus subsequent requests for the same web page document made during the time to live can be retrieved directly from one of the proxy cache 310. Advantageously, where embodiments of the present invention use http for communicating request for ratings and responses, the proxy cache 310 may be a standard off-the-shelf web proxy cache. In this case, an XML document with ratings information may be stored and associated with a web page document url instead of the content for the web page document as is typically done with a standard off-the-shelf web proxy cache. This allows embodiments of the invention to be implemented with a significant cost savings.

While the DRTR modules 306 help to provide a short term solution for ratings not in the local cache 302 or the master ratings database 304, an appropriate solution is needed for more thorough ratings that have a longer cacheability. Thus, in one embodiment, a dynamic background rating service (DBRS) 312 continuously rates web page documents for addition to the master ratings database 304 and the local caches 302 in the ratings servers 118. The DBRS 312 has automated rating modules that, although slower in response time when compared to the DRTR modules 306, are more accurate in their rating of web page documents than the DRTR modules 306. The automated rating modules of the DRBS 312 may be such that they also return a confidence level indicating the confidence that a rating is correct. If the confidence level is sufficiently high, the rating generated by the automated rating modules of the DRBS 312 may be added to the master ratings database 304 and subsequently during a batch update to each of the local caches 302. Additionally, the ratings may also be cached in the proxy caches 310 and given a longer time to live. For this to happen, DBRS 312 would send an update to the load balancer 308. When proxy cache 310 entries expire, the new more reliable rating is returned by the load balancer 308 to the proxy cache 310.

If a web page document cannot be rated or rated with a sufficient confidence level, the web page document will be rated by hand. Hand rating involves a human rater examining the page and assigning the page to various categories based on the examination of the page. Ratings for the web page document are then added to the master ratings database 304, where they will be subsequently updated in a batch update to the local caches 302 on the ratings servers 118.

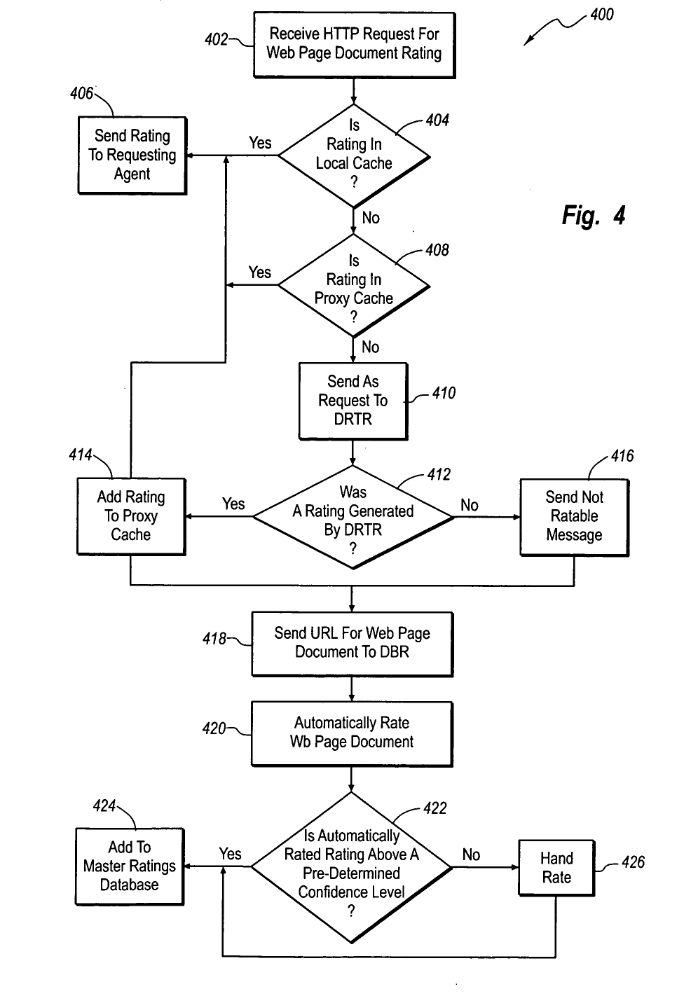

Referring now to FIG. 4, a method is illustrated where a rating service such as the ratings service 300 shown in FIG. 3, is used to provide web page document ratings to an agent device such as the router 104 in FIG. 1. The method 400 shows that an http ratings request is received (act 402). The http ratings request includes at least a url to a web page document for which a rating is desired. A check is then done to see if a rating for the web page document is in a local cache (act 404) such as the local cache 302 shown in FIG. 3. If the rating is in the local cache, then the rating is sent to an agent device that submitted the http request (act 406).

If no rating is in the local cache, a check is done to see if a rating for the web page document is in a proxy cache (act 408) such as the proxy cache 310 shown in FIG. 3. If a rating for the web page document is in the proxy cache, the rating is sent to the agent device that submitted the http request (act 406).

If no rating is in the proxy cache, a request for dynamic rating is made such as by sending a request to a DRTR (act 410) such as the DRTR modules 306 shown in FIG. 3. The DRTR tries to perform an automated rating of the requested web page document. This automated rating may be done, in one embodiment, using text patterns to determine the nature of a web page document. A check is then performed to determine if a rating was generated by the DRTR (act 412). If a rating was generated, the rating is added to the proxy caches (act 414). The rating is then sent to the agent device that submitted the http request for rating (act 406). Those of skill in the art will appreciate that the acts described above do not necessarily need to be performed in the order indicated. Thus, embodiments of the invention as claimed herein, unless specifically recited, do not require the acts to be performed in any particular order. As one specific example, embodiments of the invention will not necessarily depend on the timing that the rating is sent to an agent device or a proxy cache.

Occasionally, the web page document will not contain a sufficient amount of the right kind of data to generate an accurate rating. In this case, a not ratable message will be sent to the agent device that submitted the http request for rating (act 416).

In either case, whether the web page document is ratable by the DRTR or not, the url for the web page document is sent to a DBR, such as the DBRS 312 shown FIG. 3, for rating (act 418). At the DBR, an attempt to automatically rate the web page document will be made (act 420). The automatic rating at the DBR has more advanced tools for rating, but may require more time than the DRTR to rate web page documents. Also, the DBR may be able to rate web page documents that the DRTR was not able to rate. For example, the DBR may include software for examining patterns in images to determine what types of images are present. In another example, the DBR may examine the web page documents or ratings for the web page documents that are linked to in the web page document, or pages that link to the web page document. This is done because often web pages will link to similar web pages. While the DBR requires more computing overhead and time, it also generates a more accurate rating.

The automatic rating at the DBR also generates a confidence rating indicating a degree of confidence for a particular rating. A check is done to see if the confidence rating falls above some predetermined threshold (act 422). If the confidence rating is above the predetermined threshold, the rating is added to the master ratings database (424) where it will eventually be distributed to the local caches in the ratings servers.

If the confidence level falls below a predetermined threshold, the web page document is sent to hand raters for hand rating (act 426). The hand raters are human raters that examine the web page document and then provide a rating based on the content of the web page document. The hand ratings are then added to the master ratings database (act 424). Hand rated web page documents may be given a longer time to live in cache than some other automatically rated web page documents because of the certainty of the content in the web page document.

Notably, the above description illustrates exemplary embodiments of the present invention and various modifications or changes may be made to the embodiments described above where those modifications and changes still fall within the scope of the present invention. For example, and not by way of limitation, the firewall 112 and router 104 in FIG. 1 may be embodied as a single device as opposed to the two separate devices shown. In one embodiment, the ratings request and processing module 116 and policy module 120 may be installed on the firewall 112. In one embodiment, the network client 102 may be connected directly to the firewall 112 without the use of the router 104. In another embodiment, the network client 102 may be connected directly to the Internet 110 through the use of a modem or other connection. In this embodiment the network client 102 includes software that includes the policy module 120 and ratings request and processing module 116.

In other embodiments of the invention, various administrative functions may be performed by a ratings service that maintains the ratings server 118. The ratings server 118 is generally maintained by a service provider. The service provider provides categorization service to subscribers through some form of subscription service. The ratings server 118 can provide different responses to the request for categorization of the web page document depending on the type of service subscribed to, or particular information included in the GET command issued by the router 104 to get web page document categorization. For example, as described above a GET command complying with a CMR protocol allows a request for categorization to be performed where the request includes the web page document address and a list of categories. The ratings server 118 simply returns a yes or no answer as to whether the web page document is a member of one of the categories in the list of categories. In a contrasting embodiment of the invention, an ADR protocol may be used. The ADR protocol allows more administrative functions to be performed by a ratings service. An ADR protocol GET command includes arguments including a user id corresponding to a user at a network client 102 and a web page document address. Using the ADR protocol, the ratings server 118 returns a message that indicates the web page document should be blocked or that a user should be allowed to view the web page document. In this embodiment, policy information is maintained at a ratings service. A subscriber to the ratings service can update the policy information by accessing the ratings service through a web interface such as a web browser. The rating service may further include functionality including logging functionality and other services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of controlling and/or monitoring activity including accessing web page documents through the Internet comprising:
receiving an http request for a web page document;
issuing an http request for the web page document;
issuing an http request for a rating for the web page document; and
receiving a rating for the web page document.

2. The method of claim 1 wherein receiving a rating for the web page document comprises receiving an indication that the web page document does or does not belong to a list of categories.

3. The method of claim 1, wherein the indication may be the presence or absence of a block argument.

4. The method of claim 1, wherein issuing an http request for a rating for the web page document includes issuing a request that comprises an argument that identifies a list of categories.

5. The method of claim 1, wherein issuing an http request for a rating for the web page document includes issuing a request that comprises an argument that identifies a user requesting a web page document.

6. The method of claim 1, further comprising logging the rating for the web page document.

7. The method of claim 1, further comprising blocking the web page document from a user requesting the web page document if the web page document is rated as belonging to a category of web page documents that should be blocked from the user.

8. The method of claim 7, wherein blocking comprises sending a blocking web page document to the user indicating that the requested web page document is blocked.

9. The method of claim 8, wherein the blocking web page document includes an indication of why the requested web page document is blocked.

10. The method of claim 8, wherein blocking comprises sending the blocking web page document by redirecting a request for a web page document to a web page document server with the blocking web page document.

11. The method of claim 8, wherein blocking comprises sending the blocking web page document by:
issuing an http request to a server that vends blocking web page documents;
tunneling a blocking web page document from the server that vends blocking web page documents; and
sending the tunneled blocking web page document to the user.

12. An agent device useful in filtering and/or monitoring Internet access, the agent device comprising:
a first module configured to receive an http request for a web page document
a ratings request module configured to generate an http request for a rating for the web page document; and
a WAN port coupled to the ratings request module, the WAN port being adapted to couple to the Internet to allow http requests to be forwarded to the Internet, and http messages to be delivered to the agent device.

13. The agent device of claim 12, further comprising a LAN port configured to receive an http request for a web page document from a client.

14. The agent device of claim 12, wherein the first module and the ratings request module are the same module.

15. The agent device of claim 12, further comprising a processing module configured to receive the rating for the web page document and to generate a blocking web page if the rating for the web page document indicates that the web page document should be blocked.

16. The agent device of claim 12, further comprising a processing module configured to log the rating of the web page document.

17. A service configured to provide Internet monitoring and/or filtering functionality comprising:
a ratings server, the ratings server comprising a cache, the cache comprising ratings for web page documents; and
a proxy cache coupled to the ratings server, the proxy cache being configured to respond to an http request and to deliver web page ratings stored as cached documents associated with a web page document url.

18. The service of claim 17 further comprising a dynamic rating service coupled to the proxy cache, the dynamic rating service configured to attempt to automatically rate web page documents in response to receiving a request for a web page document from the proxy cache and to return ratings for web page documents to the proxy cache if attempting automatically rate web page documents is successful.

19. The service of claim 17 further comprising a background rating service coupled to the dynamic rating service, the background rating service configured to attempt to automatically rate web page documents requested from the dynamic rating service.

20. The service of claim 19, further comprising a master ratings database coupled to the background rating service, wherein the master ratings database is configured to store ratings generated by the background rating service.

21. The service of claim 20, further comprising a distributed update module configured to update ratings in the cache using ratings from the master ratings database.

22. The service of claim 17, the ratings server further comprising policy information regarding categories of web page documents that users are permitted to access.

23. The service of claim 17, the ratings server further comprising logging information that includes a log of web page categories visited by users connected to the ratings server.

24. The service of claim 17, further comprising a plurality of ratings servers distributed in various locations.

25. The service of claim 17, wherein the ratings for web page documents are ratings for a domain or path.

26. A method of providing ratings for web page documents comprising:
receiving an http request for a web page document rating from an agent device;
checking to see if the web page document rating is in a local cache and if the web page document rating is in a local cache sending the rating to an agent device requesting the rating;
if the web page document rating is not in local cache, checking to see if the web page document rating is in a proxy cache by using an http request for the web page document and if the web page document rating is in the proxy cache, sending the web page document rating to an agent device requesting the rating;
if the web page document rating is not in the proxy cache sending a request to a dynamic rater for rating and sending the url for the web page document to a background rater; and
if the dynamic rater is able to generate a dynamic web page document rating in a reasonable amount of time, sending the rating to the agent device requesting the rating.

27. The method of claim 26, further comprising at the background rater, generating a web page document rating and a confidence level for the generated rating.

28. The method of claim 27, further comprising sending the url for the web page document to a hand rater for hand rating if the confidence level is below a predetermined threshold and adding a rating for the web page document to a master ratings database after a hand rater has provided a rating for the web page document.

29. The method of claim 27, further comprising adding a rating for the web page document to a master ratings database if the confidence level for the generated rating is above a predetermined threshold.

30. The method of claim 27, further comprising sending a message indicating that the web page document is not ratable if the dynamic rater is not able to generate a rating in a reasonable amount of time.

31. The method of claim 25, wherein receiving an http request for a web page document rating comprises receiving a user identification, the method further comprising maintaining a log of web page document categories for the user identification.
